(19) United States
(12) Patent Application Publication
(10) Pub. No.: US 2013/0287504 A1
(43) Pub. Date: Oct. 31, 2013

(54) Method and Apparatus Accelerate Gases Peripherally

(71) Applicant: Harry John Gatley, Holladay, UT (US)

(72) Inventor: Harry John Gatley, Holladay, UT (US)

(73) Assignee: Harry John Gatley, Holladay, UT (US)

(21) Appl. No.: 13/557,017

(22) Filed: Jul. 24, 2012

(51) Int. Cl. B65G 51/02

(52) U.S. Cl. CPC B65G 51/02
USPC 406/191

(57) ABSTRACT

The present invention took the inventor 15 years to develop, it was inspired by the possibility he saw of accelerating gases peripherally along the inside of cylindrical hollow tubes, ducts and pipe He took the rocket nozzle type of venturi and formed it in annular and rectangular shapes. The inventor applied his knowledge of supersonic and hypersonic fluid mechanics to industrial process conditions.

### OTHER RELEVANT APPLICATIONS

Provisional Patent 60/090,646, Jun. 28, 1998

Provisional Patent 60/092,263, Jul. 10, 1998

The Ultra Gravity Dry Fractionation System, continuation of U.S. Ser. No. 09/821,844

patent application Ser. No. 09/440,076

Provisional Patent 61/313,732

### FIELD OF THE INVENTION

The present invention relates to an apparatus for the creation of fluid flows as boundary layers at supersonic and hypersonic speeds. This design of a nozzle in either annular or rectangular shape creates a method of accelerating fluids to speeds above Mach 1. This fluid boundary layer separates a subsonic region and a solid surface. This fluid layer is relatively thin however it has two faces: one at the solid surface the other at a subsonic fluid surface. This boundary layer imparts momentum to the subsonic fluid inside of it and to any solids carried in the inner space. It provides a boundary that is hard enough to resist the passage of the solids through it. This has been tested with chicken manure and observed to eliminate solids contact with the inner walls of pipe even around bends. This test was done in a pilot plant. The concept of a venturi operating as a critical flow nozzle is well understood and used for example in rockets. The coaxial nozzle does not exist however nor does the rectangular shape used in a cyclone for the prevention of contact between solids and the cyclone inner wall. This design has been modeled mathematically and verified by several experts in the field of pneumatic conveying and It is intended to exploit this nozzle concept uniquely in the transportation of solids such as coal and ore. In a similar embodiment the fluid is gas generated from an explosive charge in a shell that prevents the projectile from contacting the gun barrel. This allows a projectile to be accelerated to speeds above the maximum high explosive velocity, cf. C3 Mach 22. In a typical gun the speed of the projectile is limited by friction heat to the point where melting of the projectile and barrel occurs whence the barrel is plugged causing it to explode. In the conveyance of coal, ores or other objects such as a passenger vehicle the optimal design has a very high vacuum condition in the core of the duct such that the momentum imparted to the solids by the boundary layer faces negligible reduction by form drag.

### A BRIEF DESCRIPTION OF THE DRAWINGS

FIG. 1 Shows the basis of design of the coaxial nozzle. This drawing shows how the coaxial nozzle cross section looks and gives the basic design information especially as to how the gases travelling from right to left are affected and this is a classic nozzle design. The compression from entry a across the converging nozzle 1 increases the gas velocity. The gas mow has more energy in it as it is compressed through the throat 2. The gases then are expanded in a limited manner through the diffuser nozzle 3. The geometry of the inlet and outlet is such that the energy of compression is recovered in an increased velocity in the diffuser 3 to the point where at 4 the velocity can exceed Mach 1.

FIG. 2 Shows the design of the nozzle as applied to pneumatic conveying. The above described geometry is rotated through 360 degrees by machining concentric rings and fitting them together in an axial configuration such that the gas flow is directed through annular spaces. The bore of the two annular spaces is where the introduction of solids in a fluid is made such that these solids are carried by the annular supersonic gases.

FIG. 3 Shows the application of the invention in the embodiment of a gun. The geometry is the same as above however the solid in fluid is a projectile in a gaseous mixture of the combustion products of an explosive.

FIG. 4 shows the embodiment of the invention as applied to a cyclone. In this embodiment the same nozzle concept as in FIG. 1 is used but is stretched longitudinally by machining parallel plates and fitting them such that the rectangular gap between the parallel venturis is where the solids and fluids are introduced where they are carried by the fluids in the nozzle that have been accelerated to supersonic speeds.

### APPARATUS DESCRIPTION AND OPERATION

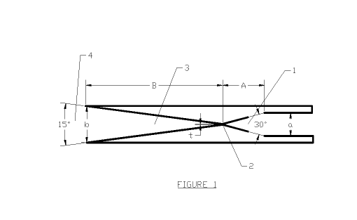

The coaxial nozzle design is shown in FIG. 1. The basis of the nozzle is the venturi, shown in FIG. 1. This is basically a rocket nozzle that is annular or rectangular in shape. An entrance section (1) compresses the gases as the velocity increases, which at the critical flow nozzle point is Mach 1. After the gases leave the throat (2) the energy of compression is recovered in the diffuser section (3) and the gases accelerate to supersonic speed. Theses gases are expelled (4) from the diffuser at a multiple Mach value proportional to the nozzle pressure drop. The dimensions of the entry cone, throat and discharge cone are of critical proportion as shown in the following equations: Where,

G=volumetric flow desired

α=cross sectional area of throat=G/c

t=annular throat width=α/π*D

D=annular venturi diameter

tᵣ=rectangular throat width=α/h

h=length of rectangular venturi section

b/t=60*

A/t=˜38

B/t=˜70

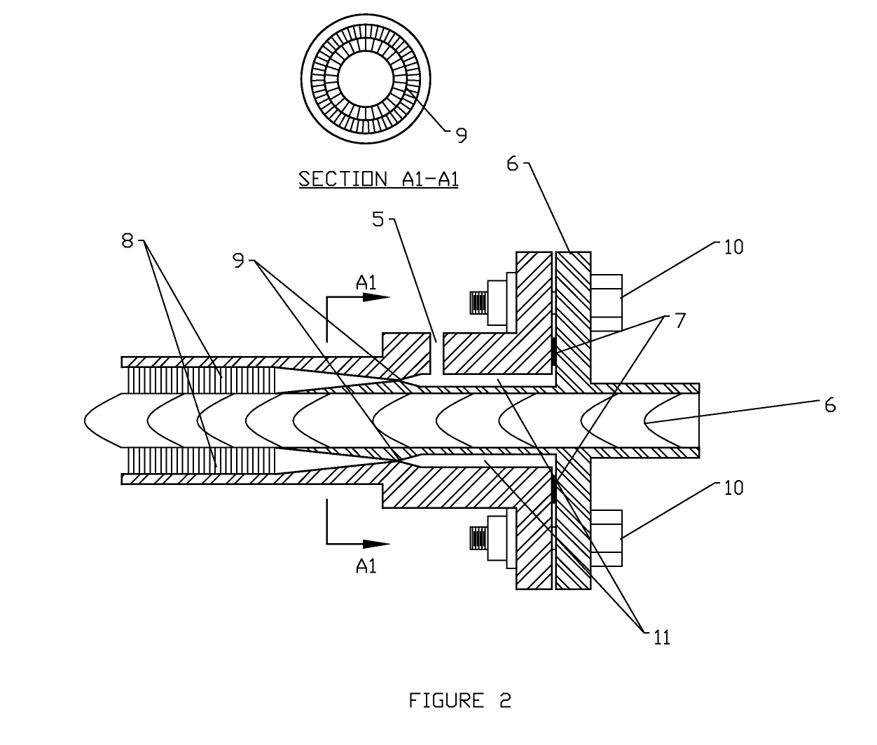

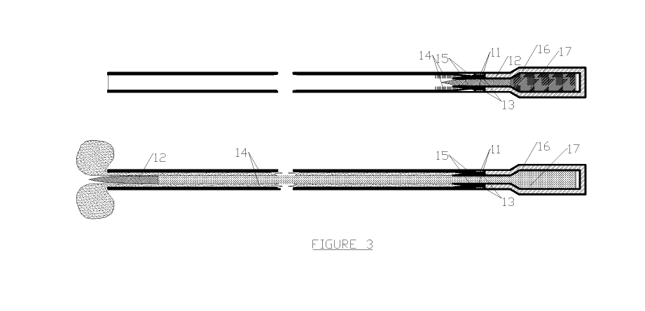

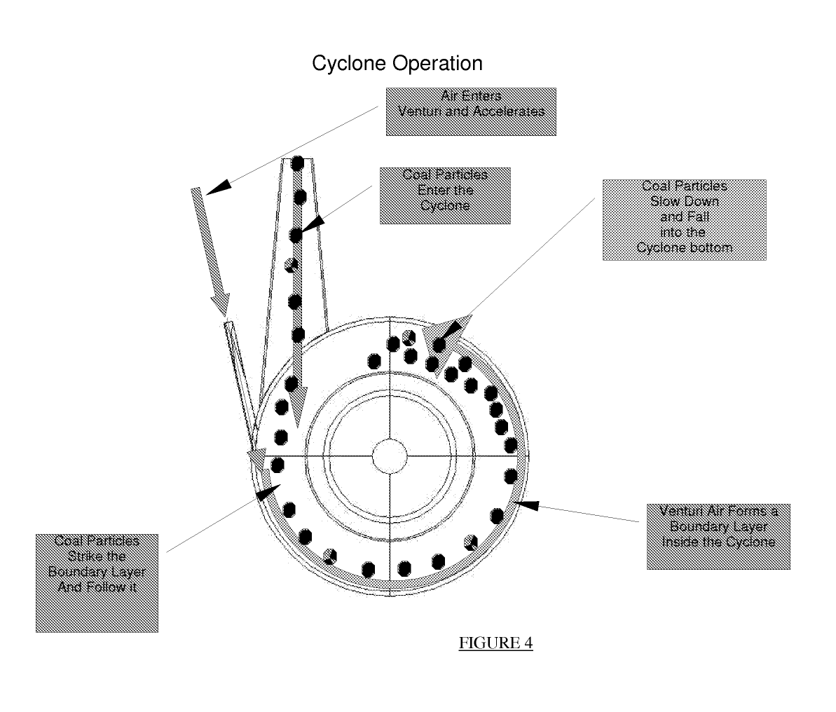

*these parameters may vary slightly as determined by CFD analysis, machine shop limitations and application conditions. The pressure drop is determined by the desired Mach number in the peripheral boundary layer by the standard methods and by modeling in a CFD program. FIG. 2 shows the assembled annular venturi as used for pneumatic conveying. The flanged (6) end on the right hand side of the apparatus is the means used to ensure the nozzle is centered in the pipes. Guide pins are fitted between the faces such that the coaxial pipes are perfectly aligned and the bolts (10) tightened to create a gas tight seal across the gasket (7). The inner pipe (8) carries the flow of fluids and solids to be carried on the supersonic boundary layer fluid (8). This fluid is introduced at (5) to a chamber upstream of the nozzle's throat (11). The ratio of areas from upstream of point (11) and the throat (9) yield an acceleration ratio of the fluid as it is compressed through the throat (9). After the fluid passes through the throat (9) the energy of compression is recovered as it expands in the downstream section creating an increase in 55 velocity in excess of Mach 1 if the pressure drop is sufficient. In FIG. 3 a similar coaxial venturi is shown inside of a gun barrel just past the firing chamber (11). The gases from the detonation of the explosive (17) pass through the holes (11) into the upstream chamber of the coaxial venturi. As above, this hot gas accelerates through the throat (15) as it is compressed and recovers this energy to form a hypersonic boundary layer (14) that provides a bearing for the projectile (12) to travel on. The projectile receives an impulse at the velocity of the explosive then is “drafted” along the barrel at increasing velocity. In FIG. 4 it is seen that a rectangular venturi applied ahead of a cyclone. In this embodiment the objective is to provide an impenetrable barrier for the solids so they cannot impact the wall. This allows for more efficient and effective separations of materials by specific gravity. These cyclones can be arranged in series with partial recirculation to effect qualitative separations such as ash from coal, base metals from silicates, gold and copper from silicates and water from solids. The acceleration of the gases past Mach 1 also generates a condensing effect by which water and other liquids condense into the boundary layer later to be separated in the cyclones.

### SUMMARY

The generation of supersonic and hypersonic fluid flows allows solids to be accelerated along ducts without the solids impacting the walls. The fluids can be gaseous or liquid and the materials in the center of the duct can be slurries, solids or viscous liquids such as crude oil. In all cases the wall friction normally associated with fluid flow through ducts is reversed. The peripheral fluid accelerates the inner fluids and all they contain. Since the peripheral flow is much smaller than the bulk of the axial flow it takes less energy to move it along the duct. Frictional losses are seen between the supersonic fluid and the wall however the ultra high momentum of the coaxial fluid is able to resist friction losses for very great distances. In the case of the gun barrel however distance and friction losses are of negligible concern. Using a vacuum pump and compressor in series also allows for very high Mach numbers whereby the center of the duct is nearly full vacuum very low resistance to flow 80 is seen by solids and they behave as if in deep space. They collide with the peripheral boundary layer and momentum is established that is not reduced significantly with distance. The boundary layer is reestablished by allowing more air to be compressed and fed into new coaxial venturis over distances that approach 10 km each. Therefore it has been seen that a 16 inch HDPE pipe can carry up to 28,000 tonnes per hour over 500 km absorbing 10,000 HP. This is to be tested in a pilot plant by IIT, India and developed commercially in Mozambique in 2016. Since the system dries the coal as it is transported there is no need for coal drying at the mine site. In fact this system allows for ash separation without going to wet flotation and heavy media separation methods. This represents a major break though in the processing of coal and minerals.

### REFERENCES

1) Perry's Chemical Engineer's Handbook, 8^{th} Edition, Don W. Green, Robert H. Perry McGraw Hill, ©2008.
2) Mark's Handbook of Mechanical Engineering, 8th Edition, pg 11-76, Baumeister et al, McGraw-Hill, ©1978.
3) An Experimental and CFD Study of a Supersonic Coaxial Jet, A. D. Cutler, J. A. White, American Institute of Aeronautics and Astronautics, ©2001

### References:

U.S. Pat. No. 5,863,155 “A system for conveying particulate material from a first location to a second location. The system includes an auger rotatably disposed in a cylindrical auger chamber having a discharge end coupled to an inwardly-tapering nose cone. The nose is attachable to an elongate conveying conduit for conveying the particulate material. First and second plenum chambers co-act to inject concentric annular waves of pressurized fluid into the nose cone at an entry point adjacent to the discharge end of the nose cone. The arrangement provides a substantially laminar gas layer which lines the interior surface of the conveying conduit and circumscribes a flowing stream of gas and particulate material to thereby minimize contact of the particulate material with the interior surface of the conveying conduit.”

This patent is very different than the apparatus in the application. It follows on from similar designs that began in 1926 U.S. Pat. No. 1,578,954 as a method of mixing propulsion air with solids conveyed along a pipe and metered by a screw conveyor. The present invention is the opposite in nature in that the center of the duct is filled with a solid fluid mixture and there is a supersonic or hypersonic boundary layer that drags the solids along. The references are incapable of achieving supersonic boundary layer flows. In fact the cone configuration can never create a flow over Mach 1 and is a laminar boundary layer created by the slipping of the air next to the wall. This phenomenon has been observed in rocket nozzle discharges and this boundary layer phenomenon runs counter to rocket propulsion efficiency. The required recovery of energy from a conical transition to achieve supersonic velocity necessitates a diffuser section of a particular geometry, which is what is generated in the present invention. This rocket nozzle however is annular or rectangular in shape, which has not been done in any other setting.

U.S. Pat. No. 5,718,539 as above is very similar and the same reasoning separates and distinguishes the embodiments of the invention.

1. It is claimed that this invention accelerates solids in fluids at supersonic and hypersonic speeds.

2. It is claimed that this invention creates supersonic and hypersonic boundary layers between solids carried by a fluid and the inner surfaces of pipes, ducts and equipment preventing contact with the walls around bends and along straight sections.

3. It is claimed that this invention vastly reduces the transportation costs for all types of solids over great distances supplanting rail and mechanical conveyors.

4. It is claimed that an embodiment of this invention will allow safe supersonic transportation of people in gondolas through tubes over great distances and at very low cost.

5. It is claimed that moisture adhering to solids travelling in this apparatus is shed drying the solids due to the effect of supersonic speed moisture separation as observed at the nose of jets breaking the sound barrier and that this moisture (water or other) migrates to the supersonic boundary layer separating it from the solids so the invention also is a dryer.

6. It is claimed that the use of this technology with cyclones in series allows for qualitative separation of solids ash from coal and gold, silver, copper, etc. from ore for example or contaminants from pharmaceuticals.

7. It is claimed that this invention prevents projectiles from reaching the “Maraging Point” where friction between the projectile and barrel leads to fusing of the two metals causing the barrel to fail.
